(19) United States
(12) Patent Application Publication
(10) Pub. No.: US 2025/0172827 A1
(43) Pub. Date: May 29, 2025

(54) METHOD AND APPARATUS FOR DYNAMICALLY CONTROLLING THE COUPLING STATE BETWEEN GUIDED MODES AND PLASMONIC RESONANCES IN A PLASMONIC MULTIMODE OPTICAL FIBER

(71) Applicants: FONDAZIONE ISTITUTO ITALIANO DI TECNOLOGIA, Genova (IT); CONSEJO SUPERIOR DE INVESTIGACIONES CIENTIFICAS, Madrid (ES)

(72) Inventors: Ferruccio PISANELLO, Genova (IT); Liam COLLARD, Genova (IT); Filippo PISANO, Genova (IT); Antonio BALENA, Genova (IT); Marco PISANELLO, Genova (IT); Di ZHENG, Genova (IT); Massimo DE VITTORIO, Genova (IT); Liset MENENDEZ DE LA PRIDA, Madrid (ES)

(21) Appl. No.: 18/841,355

(22) PCT Filed: Feb. 24, 2023
(86) PCT No.: PCT/EP2023/054721

§ 371 Date: Aug. 23, 2024

(30) Foreign Application Priority Data
Feb. 25, 2022 (IT) 102022000003587

(51) Int. Cl. G02F 1/01; G02B 5/00; G02B 6/028; G02B 6/10

(52) U.S. Cl. CPC G02F 1/0115; G02B 5/008; G02B 6/0288; G02B 6/107; G02F 2203/10

(57) ABSTRACT

A method for dynamically controlling the coupling state between guided modes and plasmonic resonances in a plasmonic multimode optical fiber is provided. The method involves providing a set of phase modulation components ϕ_{interfere}^{j}^{ₓ}^{,j}^{_{y}}^{,p}(uᵢₙ,vᵢₙ) to be applied to an input light field entering an input facet of the plasmonic multimode optical fiber, determining a computed phase modulation Φ(uᵢₙ,vᵢₙ) to be applied to the input light field to produce a coupling between the guided modes and the plasmonic resonances, the computed phase modulation being defined as a combination of the phase modulation components, ϕ_{interfere}^{j}^{ₓ}^{,j}^{_{y}}^{,p}(uᵢₙ,vᵢₙ), and applying the computed phase modulation Φ(uᵢₙ,vᵢₙ) to a laser beam entering the input facet of the plasmonic multimode optical fiber.

The project leading to this application has received funding from the European Union's Horizon 2020 research and innovation programme under grant agreement No. 828972 (nanoBRIGHT).

The present invention relates to a method and apparatus for controlling the coupling state between guided modes and plasmonic resonances in a plasmonic multimode optical fiber, said plasmonic multimode optical fiber comprising an input facet, an output facet and a plasmonic structure formed on the output facet.

The ability to realize plasmonic structures on the output facet of multimode optical fibers has enabled a set of integrated functionalities, using guided light to exploit the intrinsic properties of either Surface Plasmon Resonances (SPR) or Localized SPR (LSPR). Enhanced sensing, near-field optical microscopy, high-efficiency second-harmonic generation, plasmonic lab-on-fiber, and integrated phase shift/beam steering are primary examples of those promising applications. Still, the pivotal point of achieving full control over the photonic properties of the entire optical system in both static dynamic fashions remains unsolved.

Micro- and nano-fabrication and electromagnetic engineering indeed cannot account for the intrinsic complexity of the fiber transmission. In fact, the fiber is a highly turbid medium that substantially alters the propagation of light wavefronts up to the point that any initial spatial coherence is practically lost. Although using single mode fibers allows circumventing this problem, this comes at the cost of a limited control on the resonant patterns at the output facet, which are almost completely determined by the structural morphology. Instead, harnessing the interaction between plasmonic modes on the fiber tip and the full set of modes guided in a multimode fiber (MMF) can bring this technology to achieve its full potential.

EP2756349A2 discloses a holographic interferometric method for controlling light transmission through a multimode optical fiber in which, however, no plasmonic structure is taken in account. Plasmonic structures insert an additional layer of complexity to light propagation, making conduction electrons interacting with the light field and defining a dispersion diagram that features resonances. In addition, the plasmonic structure features sub-wavelength features, in all spatial dimensions, that play a crucial role in its response. Therefore, optical propagation rules through a generic medium (either scattering, turbid, homogeneous or not, absorbing or transparent) are insufficient to describe the physics of the coupled system composed by guided modes and plasmonic resonances.

Ditlbacher et al. “Coupling dielectric waveguide modes to surface plasmon polaritons”, Optics Express, vol. 16 No. 14, p. 10455, 7 Jul. 2008 describes the study of thin film multilayers used for the coupling of dielectric waveguide modes to surface plasmons. The combination of dielectric waveguide modes for long-range light field propagation and SPP elements enabling highly confined local light field manipulation. This paper introduces a hybrid waveguide system built from a metal-clad dielectric waveguide and a metal interface and analyzes its properties in terms of an extended layer system.

Čižmár et al. “Shaping the light transmission through a multimode optical fiber: complex transformation analysis and applications in biophotonics”. Optics Express, vol. 19 No. 20, p. 18871, 26 Sep. 2011 discloses laser light propagation through multimode optical fibers and light control at the fiber output. Beam-shaping with a spatial light modulator obtains a decomposition of the initial laser field into a series of orthogonal modes each corresponding to a different square region (sub-domain) of the SLM. A “reference mode” and a “test mode” propagating on optical fibers, interfere with output fiber facet, and the result signals of amplitude are observed in CCD camera. Subsequently, the amplitude evolution is recorded varying the phase of “test mode”. Repeating this procedure for all the input modes and then turning them ‘on’ simultaneously with the optimal phase results in optimum focusing of the signal.

Kwak et al. “Fiber-optic plasmonic probe with nanogap-rich Au nanoislands for onsite surface-enhanced Raman spectroscopy using repeated solidstate dewetting”. Journal of Biomedical Optics 24 (3), 037001, 14 Mar. 2019 describes a system made by a fiber-optic plasmonic probe for on-site SERS analysis. In particular, a multimode fiber with plasmonic nanoislands on top surface, molded with a solid-state dewetting technique. The system consists in an excitation laser coupled through the end of the multimode fiber with small biomolecules attached near the SERS-active fiber-top surface. The same fiber collects the signals, and then comes back to a spectrometer for the analysis.

L. Collard et al. “Wavefront engineering for controlled structuring of far-field intensity and phase patterns from multimodal optical fibers”, APL Photonics 6, 051301, 4 May 2021 discloses an adaptive optic method used to perform complex far-field structuring of the emission of a MMF, based on a phase modulation using a spatial light modulator at the input of a multimode fiber to generate multiple, low divergence rays with controlled angles and phase at the fiber output.

An aim of the invention is to provide a method and related apparatus allowing a dynamic and selective control of the coupling between multimodal optical fiber guided modes and the resonances of plasmonic structures realized on the output facet of a plasmonic multimode optical fiber.

In accordance with this aim, the invention proposes a method for dynamically controlling the coupling state between guided modes and plasmonic resonances in a plasmonic multimode optical fiber, said plasmonic multimode optical fiber comprising an input facet, an output facet and a plasmonic structure formed on the output facet, wherein the method comprises the steps of:
a) providing a set of phase modulation components ϕ_{interfere}^{j}^{ₓ}^{,j}^{_{y}}^{,p}(uᵢₙ,vᵢₙ) to be applied to an input light field entering the input facet of the plasmonic multimode optical fiber, each phase modulation component ϕ_{interfere}^{j}^{ₓ}^{,j}^{_{y}}^{,p}(uᵢₙ,vᵢₙ) causing an associated intensity distribution of the electromagnetic field on the plasmonic structure NF^{j}^{ₓ}^{,j}^{_{y}}^{,p}(xₒᵤₜ,yₒᵤₜ) and an associated angular radiative pattern after the output facet of the plasmonic multimode optical fiber measured by the field image FF^{j}^{ₓ}^{,j}^{_{y}}^{,p}(uₒᵤₜ,vₒᵤₜ);
b) determining a computed phase modulation Φ(uᵢₙ,vᵢₙ) to be applied to the input light field to produce coupling between guided modes and plasmonic resonances, defined by a target intensity distribution of the electromagnetic field on the plasmonic structure and/or a target angular radiative pattern after the output facet of the plasmonic multimode optical fiber, said computed phase modulation being defined as a combination of the phase modulation components ϕ_{interfere}^{j}^{ₓ}^{,j}^{_{y}}^{,p}(uᵢₙ,vᵢₙ), wherein said combination of the phase modulation components is computed based on the intensity distributions NF^{j}^{ₓ}^{,j}^{_{y}}^{,p}(xₒᵤₜ,yₒᵤₜ) or field images FF^{j}^{ₓ}^{,j}^{_{y}}^{,p}(uₒᵤₜ,vₒᵤₜ) associated to the phase modulation components ϕ_{interfere}^{j}^{ₓ}^{,j}^{_{y}}^{,p}(uᵢₙ,vᵢₙ) and the target intensity distribution and/or target angular radiative pattern, said intensity distributions NF^{j}^{ₓ}^{,j}^{_{y}}^{,p}(xₒᵤₜ,yₒᵤₜ) or field images FF^{j}^{ₓ}^{,j}^{_{y}}^{,p}(uₒᵤₜ,vₒᵤₜ) being analysed to calculate, for each point (jₓ,j_{y}) of an array of points on said input facet (11), phase shifts p=pₒₚₜ^{j}^{ₓ}^{,j}^{_{y}} that generate said target intensity distribution or said target angular radiative pattern, over an ensemble of targeted pixels; and
c) applying the computed phase modulation Φ(uᵢₙ,vᵢₙ) to a laser beam entering the input facet of the plasmonic multimode optical fiber, said laser beam having a wavelength chosen on the basis of the energy dispersion characteristics and resonant wavelengths of the plasmonic structure.

In the present disclosure, the “intensity distribution of the electromagnetic field on the plasmonic output facet” is intended as the spatial and temporal distribution of intensity of the radiative electromagnetic field as modulated by the plasmonic structures at a distance measurable within a few units of the excitation wavelength of the laser beam. In particular, such a distance may be less than 5 units of the excitation wavelength.

The “angular radiative pattern after the output facet of the plasmonic multimode optical fiber” is intended as the spatial and temporal distribution of intensity of the radiative electromagnetic field as modulated by the plasmonic structures at a distance that is significantly larger than the excitation wavelength. In particular, such a distance may be greater than 5 and up to 10⁴ units of the excitation wavelength.

A further object of the invention is an apparatus for dynamically controlling the coupling state between guided modes and plasmonic resonances in a plasmonic multimode optical fiber, said plasmonic multimode optical fiber comprising an input facet, an output facet and a plasmonic structure formed on the output facet, wherein the apparatus comprises:
a wavefront shaping device configured to phase-modulate the wavefront of a wavelength tunable laser beam,
a microscope objective optically conjugated with the wavefront shaping device and configured to focus the modulated wavefront on the input facet of the plasmonic multimode optical fiber,
a spatially resolved detectors arrangement optically conjugated with the output facet of the plasmonic multimode optical fiber, said detecting arrangement comprising a first detector configured to image the intensity distribution of the electromagnetic field on the output facet and a second detector configured to image the far field response of the output facet, and
a control unit configured to
a) store a set of phase modulation components ϕ_{interfere}^{j}^{ₓ}^{,j}^{_{y}}^{,p}(uᵢₙ,vᵢₙ) to be applied to an input light field entering the input facet of the multimode optical fiber, each phase modulation component ϕ_{interfere}^{j}^{ₓ}^{,j}^{_{y}}^{,p}(uᵢₙ,vᵢₙ) causing the light field to generate an associated intensity distribution NF^{j}^{ₓ}^{,j}^{_{y}}^{,p}(xₒᵤₜ,yₒᵤₜ) of the electromagnetic field on the plasmonic structure and an associated angular radiative pattern FF^{j}^{ₓ}^{,j}^{_{y}}^{,p}(uₒᵤₜ,vₒᵤₜ) after the output facet of the plasmonic multimode optical fiber on the spatially resolved detectors arrangement;
b) determine a computed phase modulation Φ(uᵢₙ,vᵢₙ) to be applied to the input light field to produce coupling between guided modes and plasmonic resonances, defined by a target intensity distribution of the electromagnetic field on the plasmonic structure and/or a target radiative pattern after the output facet of the plasmonic multimode optical fiber on the spatially resolved detectors arrangement, said computed phase modulation being defined as a combination of the phase modulation components ϕ_{interfere}^{j}^{ₓ}^{,j}^{_{y}}^{,p}(uᵢₙ,vᵢₙ), wherein said combination of the phase modulation components is computed based on the intensity distributions NF^{j}^{ₓ}^{,j}^{_{y}}^{,p}(xₒᵤₜ,yₒᵤₜ) or field images FF^{j}^{ₓ}^{,j}^{_{y}}^{,p}(uₒᵤₜ,vₒᵤₜ) associated to the phase modulation components ϕ_{interfere}^{j}^{ₓ}^{,j}^{_{y}}^{,p}(uᵢₙ,vᵢₙ) and the target intensity distribution and/or target angular radiative pattern, said intensity distributions NF^{j}^{ₓ}^{,j}^{_{y}}^{,p}(xₒᵤₜ,yₒᵤₜ) or field images FF^{j}^{ₓ}^{,j}^{_{y}}^{,p}(uₒᵤₜ,vₒᵤₜ) being analysed to calculate, for each point (jₓ,j_{y}) of an array of points on said input facet (11), phase shifts p=pₒₚₜ^{j}^{ₓ}^{,j}^{_{y}} that generate said target intensity distribution or said target angular radiative pattern, over an ensemble of targeted pixels; and
c) control the wavefront shaping device to apply the computed phase modulation Φ(uᵢₙ,vᵢₙ) to the laser beam, said laser beam having a wavelength chosen on the basis of the energy dispersion characteristics and resonant wavelengths of the plasmonic structure.

The proposed method and apparatus allow to control the coupling state between guided modes and the resonance state of plasmonic structures realized on the distal facet of a multimode optical fiber. The phase of the input wavefront into the plasmonic fiber is controlled with a wavefront shaping element (e.g. a spatial light modulator or a digital micromirror device). The resonances resulting from the interaction between conduction electrons and guided modes are monitored simultaneously in both the intensity distribution of the electromagnetic field on the output facet of the plasmonic multimode optical fiber and the radiative angular response of the plasmonic multimode optical fiber after the output facet. By defining a target optical response in one or both planes the optical system is forced to work in a well-defined coupling state, enabling:
Control of the workpoint in the dispersion diagram, in both a static and dynamic fashion,
Spatial-selective activation of near-field enhancement of the plasmonic fiber facet,
Wavevector encoding and decoding of the interaction between guided and free-space light propagation.

This directly leads to applications in:
spatially-resolved plasmonic endoscopy by exploiting Surface Enhancement Raman Scattering for molecular sensing,
   spectrally-selective imaging exploiting wave-vector encoding through Extraordinary Optical Transmission.

Advantageously, the plasmonic fiber can feature any type of plasmonic structure on its output facet, since the modulation input field is defined upon a measure of the available photonic states.

Further characteristics and advantages of the proposed device will be presented in the following detailed description, which refers to the attached drawings, provided purely by way of non-limiting example, in which:

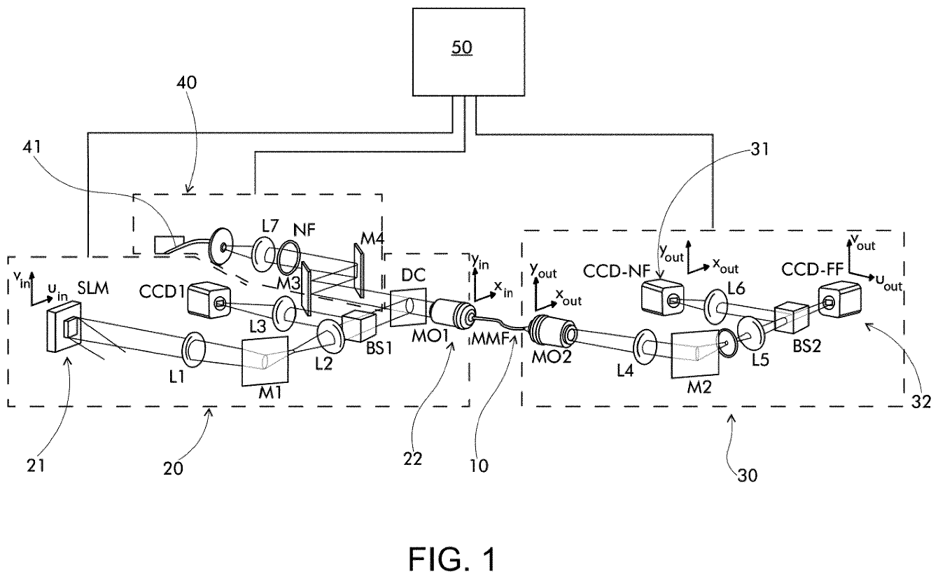

FIG. 1 shows the layout of an exemplary apparatus according to the invention;

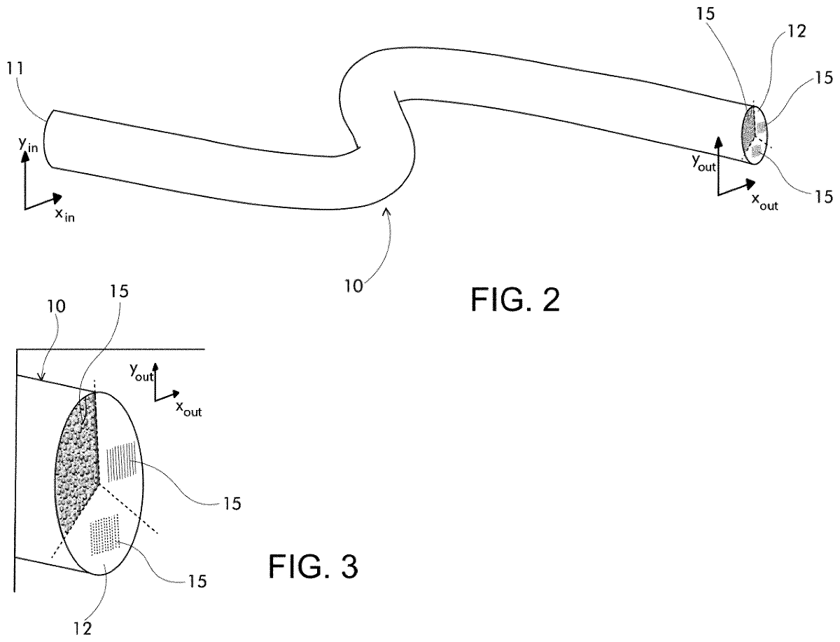

FIG. 2 is an enlarged view of a plasmonic multimode optical fiber of the apparatus of FIG. 1;

FIG. 3 is a further enlarged view of an output facet of the fiber of FIG. 2;

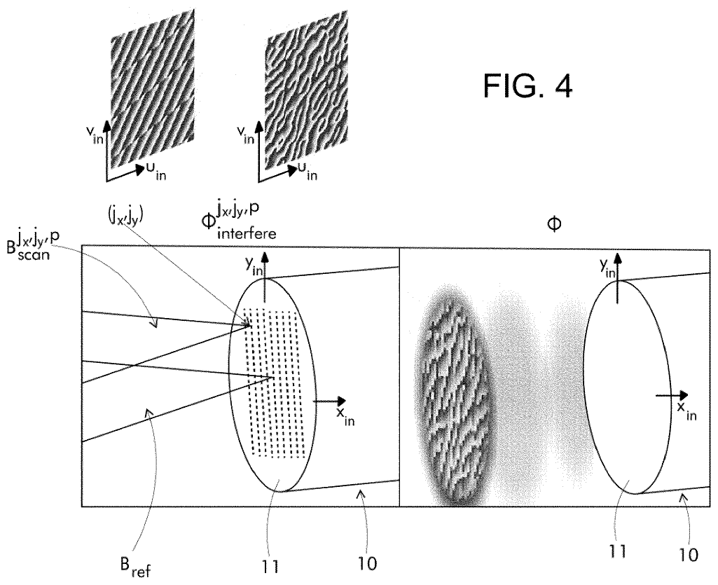

FIG. 4 shows a phase pattern denoted ϕ_{interfere}^{j}^{ₓ}^{,j}^{_{y}}^{,p}(uᵢₙ,vᵢₙ) in the plane of a spatial light modulator, and able to produce two beams B_{ref} and B_{scan} in the (xᵢₙ,yᵢₙ) plane of the input facet of the fiber, and a computed phase modulation Φ(uᵢₙ,vᵢₙ) able to produce a target intensity pattern of the electromagnetic field on the plasmonic output facet or a target far field intensity pattern; and

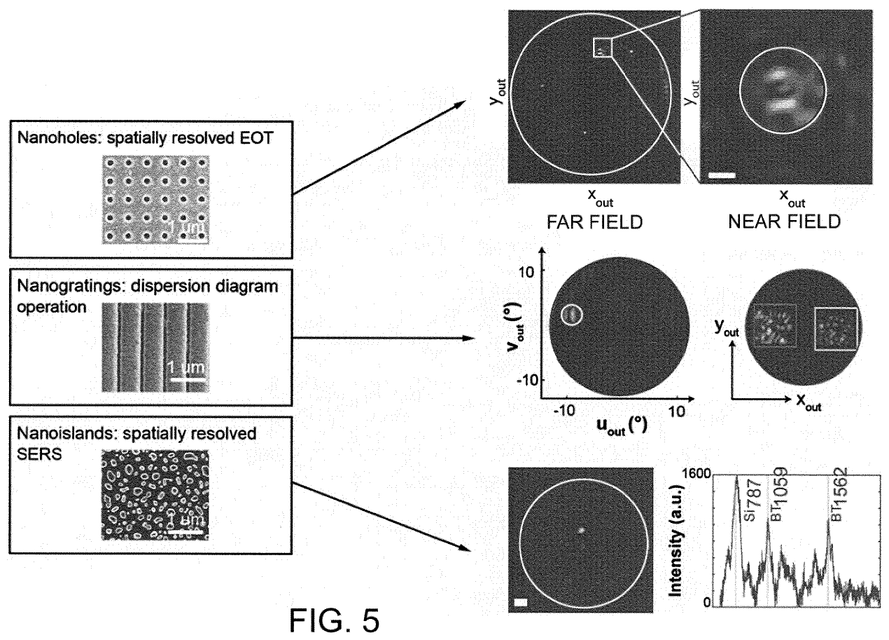

FIG. 5 shows different applications of the invention (top to bottom): Activation of a sub-portion of a nanohole array for extraordinary optical transmission, wave vector encoding, spatially resolved enhanced sensing.

FIG. 1 shows the layout of an exemplary apparatus for controlling the optical coupling between guided modes and the resonance state of plasmonic structures realized on the distal facet of a plasmonic multimode optical fiber 10. As shown in FIGS. 2 and 3, the plasmonic multimode optical fiber 10 comprises an input facet 11, an output facet 12, and a plasmonic structure 15 formed on the output facet 12. In the example shown in the drawings, there are three different plasmonic structures 15, i.e. an array of nanoholes, a nanograting and a pattern of nanoislands. The plasmonic fiber 10 may range from a few centimeters long to several tens of centimeters, and may consists of a step index multimode fiber with plasmonic structures realized on its output facet.

The optical apparatus of FIG. 1 allows for controlling the coupling state between guided modes in the plasmonic multimode fiber 10 and the plasmonic structures 15 realized on its output facet 12. The intensity and phase of the input wavefront into the fiber is controlled with a wavefront shaping element (a spatial light modulator or a digital micromirror device) and the response of the coupled system monitored simultaneously in both the near and far-field planes of the distal plasmonic facet together with the backscattered signal emerging from the proximal facet. By defining a target optical response in one or both planes the optical system is forced to work in a well-defined state, enabling:
Dynamic control of the workpoint in the dispersion diagram
Spatial-selective activation of near-field enhancement of the plasmonic fiber facet.
Wavevector encoding and decoding of the interaction with guided light and free-space propagation

This directly leads to applications in spatially-resolved plasmonic endoscopy by exploiting Surface Enhanced Raman Scattering for molecular sensing and Extraordinary Optical Transmission.

The system shown in FIG. 1 comprises an excitation block 20, the plasmonic multimode fiber 10, a monitoring block 30 and a collection block 40. These blocks are controlled by a control unit 50. In FIG. 1, SLM designates a wavefront shaping element, CCD . . . designates a charge-coupled device, L . . . designates a lens, M . . . designates a mirror, BS . . . designates a beam splitter, MO . . . designates a microscope objective, DC designates a dichroic mirror and NF designates a notch filter.

The excitation block 20 is configured to send phase-modulated light (or intensity- and phase-modulated light) to the plasmonic fiber 10. A laser beam is expanded to overfill the screen of a phase-modulation element 21 (a spatial light modulator (SLM) or a digital micromirror device (DMD)), optically conjugated with the back aperture of a microscope objective (MO1) 22, focusing the modulated wavefront on the input facet 11 of the plasmonic fiber 10. The laser beam can be either continuous wave or pulsed (either fs, ps or ns), with a fixed wavelength or with a tunable wavelength in both the visible and/or the near-infrared spectral range.

The monitoring block 30 images the plasmonic output facet and its angular radiative response on two different spatially resolved detectors 31, 32 (such as CCD or CMOS cameras).

The collection block 40 collects back-propagating photons into the plasmonic fiber 10, and is employed in applications where light is recollected by the plasmonic structures 15 on the output facet 12. A spectrometer fiber is designated with 41 in FIG. 1.

The operation method of the apparatus essentially comprises three different steps: (A) A plasmonic modes measurement step, (B) a computational step and (C) a modulation step.

### (A) Measurements of the Phase of the Plasmonic Modes

Plasmonic modes excited on the output end of the plasmonic multimode optical fiber 10 are measured when applying a set of phase-modulated input light fields on the proximal end of the fiber ϕ_{interfere}^{j}^{ₓ}^{,j}^{_{y}}^{,p}(uᵢₙ,vᵢₙ), as shown in FIG. 4. In the following, we define as (xᵢₙ,yᵢₙ) (or (xₒᵤₜ,yₒᵤₜ)) the spatial coordinates in the image plane of the input (or output) facet and as (uᵢₙ,vᵢₙ) (or (uₒᵤₜ,vₒᵤₜ)) the coordinates in the Fourier plane of the input (or output) facet (these coordinates are shown in FIGS. 1 to 4).

The phase modulation in the excitation block 20 is set to a phase pattern denoted ϕ_{interfere}^{j}^{ₓ}^{,j}^{_{y}}^{,p}(uᵢₙ,vᵢₙ) in the plane of the spatial modulator 21, able to produce two beams in the (xᵢₙ,yᵢₙ) plane (FIG. 4): (i) a reference beam B_{ref} generated by a phase ϕ_{ref}(uᵢₙ,vᵢₙ), which passes into the fiber core, and (ii) a scanning beam B_{scan} that sequentially impinges on a n×m array of points (indexed by jₓ and j_{y}) on the input facet 11 of the fiber 10 with phase p ranging from 0 to 2π; every scanning beam on the input facet is indexed as B_{scan}^{j}^{ₓ}^{,j}^{_{y}}^{,p} and is generated by the phase mask ϕ_{scan}^{j}^{ₓ}^{,j}^{_{y}}^{,p}(uᵢₙ,vᵢₙ) (FIG. 4). The phase modulation applied to the excitation block 20 results as:

$${ϕ}_{interfere}^{{j}_{x} , {j}_{y} , p} ( {u}_{i n} , {v}_{i n} ) = arg ( exp ( i {ϕ}_{s c a n}^{{j}_{x} , {j}_{y} , p} ( {u}_{i n} , {v}_{i n} ) ) + exp ( i {ϕ}_{r e f} ) ) \qquad ( 1 )$$

where p represents the phase shift applied to the scanning points. By iterating on (jₓ,j_{y}) for a total of n×m points, B_{scan}^{j}^{ₓ}^{,j}^{_{y}}^{,p} scan is scanned across the input facet while keeping B_{ref} at the center of the core. For each (jₓ,j_{y}), p is incremented in steps of

$$\frac{π}{2}$$

in the range [0, 2π] for a total of P=4 phase steps.

In this way, the propagation of B_{scan}^{j}^{ₓ}^{,j}^{_{y}}^{,p} and B_{ref} through the plasmonic multimode fiber 10 generates an interference pattern that, in turn, excites plasmonic modes on the output facet 12, which is then reflected in the light field structuring in both (xₒᵤₜ,yₒᵤₜ) and (uₒᵤₜ,vₒᵤₜ) planes (CCD-NF and CCD-FF, in practical terms). The plasmonic modes can be fully defined only if light intensity patterns on both (xₒᵤₜ,yₒᵤₜ) and (yₒᵤₜ,vₒᵤₜ) planes are measured simultaneously. The system is run in all possible configurations of the triplet (jₓ,j_{y},p), for a total of n×m×4 iterations, and the images recorded by the detectors 31 and 32 saved and used in the computational step disclosed below. These images are hereafter referred to as FF^{j}^{ₓ}^{,j}^{_{y}}^{,p}(uₒᵤₜ,vₒᵤₜ) and NF^{j}^{ₓ}^{,j}^{_{y}}^{,p}(xₒᵤₜ,yₒᵤₜ), respectively. Therefore, in the measurement step n×m×P phase modulation components ϕ_{interfere}^{j}^{ₓ}^{,j}^{_{y}}^{,p}(uᵢₙ,vᵢₙ) and related n×m×P near field images NF^{j}^{ₓ}^{,j}^{_{y}}^{,p}(xₒᵤₜ,yₒᵤₜ) and n×m×P far field images FF^{j}^{ₓ}^{,j}^{_{y}}^{,p}(uₒᵤₜ,vₒᵤₜ) are generated. These phase modulation components and the related images can be stored in a memory of the control unit 50. Step (A) can be repeated at multiple input wavelengths in order to match with specific resonant wavelengths or the plasmonic structures.

### (B) The Computational Step

The computational step aims at defining the phase modulation Φ(uᵢₙ,vᵢₙ) to impress at the input light field to produce a specific intensity pattern (target intensity pattern) on (xₒᵤₜ,yₒᵤₜ) and (uₒᵤₜ,vₒᵤₜ) (see FIG. 4 for an example of Φ and FIG. 5 for examples of modulation in the (xₒᵤₜ,yₒᵤₜ) or (uₒᵤₜ,vₒᵤₜ) planes). This is done in two substeps.

Firstly, the images FF^{j}^{ₓ}^{,j}^{_{y}}^{,p}(uₒᵤₜ,vₒᵤₜ) and NF^{j}^{ₓ}^{,j}^{_{y}}^{,p}(xₒᵤₜ,yₒᵤₜ) are analysed to calculate, for each (jₓ,j_{y}) the phase shifts p=pₒₚₜ^{j}^{ₓ}^{,j}^{_{y}} that generate the aimed electromagnetic field intensity and phase on the specific plasmonic structures fabricated on the output facet and on the radiative angular response of the plasmonic multimode fiber after the plasmonic output facet over an ensemble of targeted pixels [(x′ₒᵤₜ,y′ₒᵤₜ), (x″ₒᵤₜ,y″ₒᵤₜ), . . . ] and [u′ₒᵤₜ,v′ₒᵤₜ), (u″ₒᵤₜ,v″ₒᵤₜ), . . . ]. This results in n×m triplets (jₓ,j_{y},pₒₚₜ^{j}^{ₓ}^{,j}^{_{y}}) that are then used to generate n×m phase modulation patterns through equation (1). These are then summed together to generate the (partial) phase pattern to be sent to the wavefront-shaping device 21:

$$Φ ( {u}_{i n} , {v}_{i n} ) = arg ( {\sum }_{{j}_{x} = 1}^{n} {\sum }_{{j}_{y} = 1}^{m} exp ( i {ϕ}_{s c a n}^{{j}_{x} , {j}_{y} , {p}_{opt}^{{j}_{x} , {j}_{y}}} ( {u}_{i n} , {v}_{i n} ) ) )$$

### (C) The Modulation Step

Φ(uᵢₙ,vᵢₙ) is then applied to the phase-modulation device 21 in the excitation block 20, modulating the phase of the laser beam entering the input facet. This generates the desired patterns in the (xₒᵤₜ,yₒᵤₜ) or (uₒᵤₜ,vₒᵤₜ) and therefore sets the plasmonic fiber 10 to operate in a specific condition. The wavelength of the laser beam is chosen on the basis of the resonant wavelengths of the plasmonic structure to be targeted, in agreement with the wavelengths employed in step (A). Some possible applications are for example shown in FIG. 5 and briefly discussed below:
Targeting a light intensity pattern on the plasmonic facet (xₒᵤₜ yₒᵤₜ) allows control and dynamic modulation of the local field enhancement, with applications in near-field imaging endoscopy with molecular sensitivity, spatially-resolved extraordinary optical transmission (EOT), and reconfigurable sub-diffraction structured beaming.
Targeting a pattern in the far field plane (uₒᵤₜ,vₒᵤₜ) instead allows to set the workpoint of the system in the dispersion diagram, to provide for specific output directions or beam forming, to obtain wave-vector encoding of the coupling between guided light and free-space photons.
Controlling the coupling between the guided modes of the fiber, the plasmonic modes of the structures and the optical radiation propagating outside the waveguide (both away from the tip, e.g. emission, and towards the tip, e.g. collection) to select restricted spectral and angular ranges using a wave-vector encoding strategy that is based on the complex energy-wavevector characteristic response of the plasmonic structures.

In a further embodiment (not shown), the output facet 12 of the plasmonic multimode optical fiber 10 further comprises nanometric optical sources deposited on the plasmonic structure 15. These nanometric optical sources may be, e.g., quantum dots or single layers of molecules. These nanometric optical sources are supplementary structures added to the plasmonic structure and have the function of producing a signal that directly measures the response in terms of non-radiative electromagnetic field.

In this embodiment, in the measurement step (A) a further set of phase modulation components can be determined in connection with the non-radiative electromagnetic field on the output facet 12 of the plasmonic multimode optical fiber 10 within a distance smaller than the excitation wavelength of the laser beam. A third detector in addition to the detectors 31 and 32 is provided to measure the light intensity patterns associated with the plasmonic modes excited by the further set of phase modulation components.

In this way, the coupling of the guided modes in the plasmonic multimode fiber with the spatial and temporal intensity distribution of the non-radiative electromagnetic field on the plasmonic output facet is measured and modulated within a distance smaller than the excitation wavelength by imaging the intensity of emission of the optical sources with nanometric dimensions.

1. A method for dynamically controlling the coupling state between guided modes and plasmonic resonances in a plasmonic multimode optical fiber, said plasmonic multimode optical fiber comprising an input facet, an output facet and a plasmonic structure formed on the output facet, wherein the method comprises steps of:
a) providing a set of phase modulation components ϕ_{interfere}^{j}^{ₓ}^{,j}^{_{y}}^{,p}(uᵢₙ,vᵢₙ) to be applied to an input light field entering the input facet of the plasmonic multimode optical fiber, each phase modulation component ϕ_{interfere}^{j}^{ₓ}^{,j}^{_{y}}^{,p}(uᵢₙ,vᵢₙ) causing an associated intensity distribution NF^{j}^{ₓ}^{,j}^{_{y}}^{,p}(xₒᵤₜ,yₒᵤₜ) of an electromagnetic field on the plasmonic structure and an associated angular radiative pattern after the output facet of the plasmonic multimode optical fiber measured by a field image FF^{j}^{ₓ}^{,j}^{_{y}}^{,p}(uₒᵤₜ,vₒᵤₜ);
b) determining a computed phase modulation Φ(uᵢₙ,vᵢₙ) to be applied to the input light field to produce a coupling between the guided modes and the plasmonic resonances, defined by a target intensity distribution of the electromagnetic field on the plasmonic structure and/or a target angular radiative pattern after the output facet of the plasmonic multimode optical fiber, said computed phase modulation being defined as a combination of the phase modulation components ϕ_{interfere}^{j}^{ₓ}^{,j}^{_{y}}^{,p}(uᵢₙ,vᵢₙ), components is wherein said combination of the phase modulation computed based on the intensity distributions NF^{j}^{ₓ}^{,j}^{_{y}}^{,p}(xₒᵤₜ,yₒᵤₜ) or field images FF^{j}^{ₓ}^{,j}^{_{y}}^{,p}(uₒᵤₜ,vₒᵤₜ) associated to the phase modulation components ϕ_{interfere}^{j}^{ₓ}^{,j}^{_{y}}^{,p}(uᵢₙ,vᵢₙ) and the target intensity distribution and/or target radiative angular pattern, said intensity distributions NF^{j}^{ₓ}^{,j}^{_{y}}^{,p}(xₒᵤₜ,yₒᵤₜ) or field images FF^{j}^{ₓ}^{,j}^{_{y}}^{,p}(uₒᵤₜ,vₒᵤₜ) being analysed to calculate, for each point (jₓ,j_{y}) of an array of points on said input facet, phase shifts p=pₒₚₜ^{j}^{ₓ}^{,j}^{_{y}} that generate said target intensity distribution or said target angular radiative pattern, over an ensemble of targeted pixels; and
c) applying the computed phase modulation Φ(uᵢₙ,vᵢₙ) to a laser beam entering the input facet of the plasmonic multimode optical fiber, said laser beam having a wavelength chosen on the basis of energy dispersion characteristics and resonant wavelengths of the plasmonic structure.

2. The method of claim 1, wherein the intensity distributions NF^{j}^{ₓ}^{,j}^{_{y}}^{,p}(xₒᵤₜ,yₒᵤₜ) or field images FF^{j}^{ₓ}^{,j}^{_{y}}^{,p}(uₒᵤₜ,vₒᵤₜ) associated to the phase modulation components ϕ_{interfere}^{j}^{ₓ}^{,j}^{_{y}}^{,p}(uᵢₙ,vᵢₙ) are determined in a plasmonic mode phase measurement step, said plasmonic mode phase measurement step comprising:
causing a reference beam (B_{ref}) and a scanning beam (B_{scan}) to enter the input facet of the plasmonic multimode optical fiber, wherein the reference beam (B_{ref}) has a phase modulation pattern ϕ_{ref}(uᵢₙ,vᵢₙ),
where (uᵢₙ,vᵢₙ) are coordinates in a Fourier plane of the input facet, and the scanning beam (B_{scan}) sequentially impinges on the array of points on the input facet and has a phase modulation pattern ϕ_{scan}^{j}^{ₓ}^{,j}^{_{y}}^{,p}(uᵢₙ,vᵢₙ), where (jₓ,j_{y}) are array indexes and p is a discretized phase shift ranging from 0 to 2π, wherein the reference beam (B_{ref}) and the scanning beam (B_{scan}) propagate through the plasmonic multimode optical fiber, interfere with each other and excite plasmonic modes on the output facet, thereby generating the intensity distributions NF^{j}^{ₓ}^{,j}^{_{y}}^{,p}(xₒᵤₜ,yₒᵤₜ) and field images FF^{j}^{ₓ}^{,j}^{_{y}}^{,p}(uₒᵤₜ,vₒᵤₜ) associated to the phase modulation components, respectively in an image plane of the output facet and in a Fourier plane of the output facet.

3. The method of claim 2, wherein in said plasmonic mode phase measurement step n×m×P phase modulation components ϕ_{interfere}^{j}^{ₓ}^{,j}^{_{y}}^{,p}(uᵢₙ,vᵢₙ) and n×m×P associated intensity distributions NF^{j}^{ₓ}^{,j}^{_{y}}^{,p}(xₒᵤₜ,yₒᵤₜ) or field images FF^{j}^{ₓ}^{,j}^{_{y}}^{,p}(uₒᵤₜ,vₒᵤₜ) are generated, wherein n×m is the size of the array of points and P is the total number of steps in which p is incremented from 0 to 2π.

4. The method of claim 1, wherein the output facet of the plasmonic multimode optical fiber further comprises nanometric optical sources deposited on the plasmonic structure,
wherein step a) further comprises
providing a further set of phase modulation components to be applied to the input light field entering the input facet of the plasmonic multimode optical fiber, each phase modulation component of the further set of phase modulation components causing an associated intensity distribution of a non-radiative electromagnetic field at a distance from the output facet smaller than an excitation wavelength;
wherein step b) further comprises
determining a further computed phase modulation to be applied to the input light field to produce a target intensity distribution of the non-radiative electromagnetic field, said further computed phase modulation being defined as a combination of the further phase modulation components; and
wherein step c) further comprises
applying the further computed phase modulation to the laser beam entering the input facet of the plasmonic multimode optical fiber.

5. An apparatus for dynamically controlling the coupling state between guided modes and plasmonic resonances in a plasmonic multimode optical fiber, said plasmonic multimode optical fiber comprising an input facet, an output facet and a plasmonic structure formed on the output facet, wherein the apparatus comprises:
a wavefront shaping device configured to phase-modulate a wavefront of a wavelength tunable laser beam,
a microscope objective optically conjugated with the wavefront shaping device and configured to focus the modulated wavefront on the input facet of the plasmonic multimode optical fiber,
a spatially resolved detectors arrangement optically conjugated with the output facet of the plasmonic multimode optical fiber, said spatially resolved detectors arrangement comprising a first detector configured to image an intensity distribution of an electromagnetic field on the output facet and a second detector configured to image a far field response of the output facet, and
a control unit configured to
a) store a set of phase modulation components ϕ_{interfere}^{j}^{ₓ}^{,j}^{_{y}}^{,p}(uᵢₙ,vᵢₙ) to be applied to an input light field entering the input facet of the plasmonic multimode optical fiber, each phase modulation component ϕ_{scan}^{j}^{ₓ}^{,j}^{_{y}}^{,p}(uᵢₙ,vᵢₙ) causing the input light field to generate an associated intensity distribution NF^{j}^{ₓ}^{,j}^{_{y}}^{,p}(xₒᵤₜ,yₒᵤₜ) of the electromagnetic field on the plasmonic structure and an associated angular radiative pattern after the output facet of the plasmonic multimode optical fiber on the spatially resolved detectors arrangement;
b) determine a computed phase modulation Φ(uᵢₙ,vᵢₙ) to be applied to the input light field to produce a coupling between the guided modes and the plasmonic resonances, defined by a target intensity distribution of the electromagnetic field on the plasmonic structure and/or a target radiative pattern after the output facet of the plasmonic multimode optical fiber on the spatially resolved detectors arrangement, said computed phase modulation being defined as a combination of the phase modulation components ϕ_{interfere}^{j}^{ₓ}^{,j}^{_{y}}^{,p}(uᵢₙ,vᵢₙ), wherein said combination of the phase modulation components is computed based on the intensity distributions NF^{j}^{ₓ}^{,j}^{_{y}}^{,p}(xₒᵤₜ,yₒᵤₜ) or field images FF^{j}^{ₓ}^{,j}^{_{y}}^{,p}(uₒᵤₜ,vₒᵤₜ) associated to the phase modulation components ϕ_{interfere}^{j}^{ₓ}^{,j}^{_{y}}^{,p}(uᵢₙ,vᵢₙ) and the target intensity distribution and/or target angular radiative pattern, said intensity distributions NF^{j}^{ₓ}^{,j}^{_{y}}^{,p}(xₒᵤₜ,yₒᵤₜ) or field images FF^{j}^{ₓ}^{,j}^{_{y}}^{,p}(uₒᵤₜ,vₒᵤₜ) being analysed to calculate, for each point (jₓ,j_{y}) of an array of points of said input facet, phase shifts p=pₒₚₜ^{j}^{ₓ}^{,j}^{_{y}} that generate said target intensity distribution or said target angular radiative pattern, over an ensemble of targeted pixels; and
c) control the wavefront shaping device to apply the computed phase modulation Φ(uᵢₙ,vᵢₙ) to the laser beam, said laser beam having a wavelength chosen on the basis of energy dispersion characteristics and resonant wavelengths of the plasmonic structure.

6. The apparatus of claim 5, wherein the output facet of the plasmonic multimode optical fiber further comprises nanometric optical sources deposited on the plasmonic structure, and wherein the control unit is further configured to
store a further set of phase modulation components to be applied to the input light field entering the input facet of the plasmonic multimode optical fiber, each phase modulation component of the further set of phase modulation components causing an associated intensity distribution of a non-radiative electromagnetic field at a distance from the output facet smaller than an excitation wavelength;
determine a further computed phase modulation to be applied to the input light field to produce a target intensity distribution of the non-radiative electromagnetic field, said further computed phase modulation being defined as a combination of the further phase modulation components; and
control the wavefront-shaping to apply the further computed phase modulation to a laser beam entering the input facet of the plasmonic multimode optical fiber.
